(19) United States
(12) Patent Application Publication
(10) Pub. No.: US 2003/0235460 A1
(43) Pub. Date: Dec. 25, 2003

(54) Displacement compliant joints

(76) Inventors: Yong-Mo Moon, Worcester, MA (US); Sridhar Kota, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 10/435,162

(22) Filed: May 9, 2003

Related U.S. Application Data
(60) Provisional application No. 60/379,492, filed on May 9, 2002.

(51) Int. Cl. F16B 1/00

(52) U.S. Cl. 403/291

(57) ABSTRACT

A joint member for interconnecting a first member to a second member having an input member, an output member; and a connecting assembly. The connecting assembly may include a plurality of beam member and/or a U-shaped member assembly and allows one translational degree of freedom between the connecting parts. Each of these joints provides very high degree of compliance in the desired direction of motion and very high stiffness in other directions (off-axis), without experiencing high stress concentrations commonly found in prior art designs.

### CROSS-REFERENCE TO RELATED APPLICATIONS

This application claims the benefit of U.S. Provisional Application No. 60/379,492, filed on May 9, 2002. The disclosure of which is incorporated herein by reference.

### STATEMENT OF GOVERNMENTAL SUPPORT

This invention was made with Government support under NSF Grant No. EEC95-92125 awarded by the NSF Engineering Research Center. The Government has certain rights in this invention.

### FIELD OF THE INVENTION

The present invention relates to flexure joints and, more particularly, to large displacement compliant joints that approximate the function of traditional mechanical joints, while offering the benefits of high precision, long life, and ease of manufacture.

### BACKGROUND OF THE INVENTION

As is well known in the art, rigid mechanical connections, such as hinges, sliders, universal joints, and ball-and-socket joints, allow different kinematic degrees of freedom between connected parts. However, the clearance between mating parts of rigid joints often causes backlash in mechanical assemblies. Further, there is relative motion in each of the prior art joints that causes friction, which leads to wear and increased clearances. A kinematic chain of such prior art joints compounds the individual errors from backlash and wear, thereby resulting in poor accuracy and repeatability.

In recent decades, many flexible joints have been researched and developed, most of which can be separated in one of two categories: notch-type joints (see FIGS. 1(a)-(b)) and leaf spring joints (see FIG. 1(c)). Typically, notch-type joints are used for high precision, small-displacement mechanisms. These joints have also been used to develop the field of pseudo-rigid, body-compliant mechanisms.

On the other hand, leaf spring joints typically provide the most generic flexible translational joint and are composed of sets of parallel flexible beams (FIG. 1(c)). In addition to high-precision motion stages, leaf spring joints are also widely used in medical instrumentation and MEMS devices.

The benefits gained from using conventional flexure joints come at the cost of several disadvantages that must be taken into account when designing. To overcome these disadvantages and develop better flexures, a set of criterion must be established for benchmarking. The four most important criterions are: (1) the range of motion, (2) the amount of axis drift, (3) the ratio of off-axis stiffness to axial stiffness, and (4) stress concentration effects.

Range of Motion

All flexures are limited to a finite range of motion, while their rigid counterparts rotate infinitely or translate long distances. The range of motion of a flexible joint is limited by the permissible stresses and strains in the material. When the yield stress is reached, elastic deformation becomes plastic, after which, joint behavior is uncontrollable and unpredictable. Therefore, the range of motion is determined by both the material and geometry of the joint.

Axis Drift

In addition to limited range of motion, most flexure joints also undergo imprecise motion referred to as axis drift or parasitic motion. For notch joints, the center of rotation does not remain fixed with respect to the links it connects. With translational flexures, there can be considerable deviation from the axis of straight-line motion. For example, a simple four-bar leaf spring experiences curvilinear motion.

Axial drift can be improved by adding symmetry to the design of a joint. However, this often increases the stiffness of the joint in the desired direction of motion. Further, more space is required to accommodate any symmetric joint components.

Off-Axis Stiffness

While most flexure joints deliver some degree of compliance in the desired direction, they typically suffer from low rotational and translational stiffness in other directions. A high ratio of off-axis to axial stiffness is considered a key characteristic of an effective compliant joint.

Stress Concentration

Most notch-type joints have areas of reduced cross-section through which their primary deflection occurs. Depending on the shape of these reduced cross-sections, the joints may be prone to high stress concentrations and hence a poor fatigue life, such as shown in FIGS. 1(a)-(b).

Accordingly, there exists a need in the relevant art to provide a flexible member capable of connecting two or more parts that offer a large range of motion without significant axis drift, an improved stiffness ratio, and a higher fatigue life. Furthermore, there exists a need in the relevant art to provide a compliant joint that overcomes the disadvantages of the prior art.

### SUMMARY OF THE INVENTION

According to the principles of the present invention, a joint member for interconnecting a first member to a second member having an advantageous construction is provided. The joint member includes an input member, an output member, and a connecting assembly. The connecting assembly may include a plurality of beam member and/or a U-shaped member assembly and allows one translational degree of freedom between the connecting parts. Each of these joints provides very high degree of compliance in the desired direction of motion and very high stiffness in other directions (off-axis), without experiencing high stress concentrations commonly found in prior art designs.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a series of perspective views illustrated known prior art designs:

TABLE 1 is a comparative table illustrating the functional difference of a first embodiment of the present invention relative to known prior art;

FIGS. 2(a)-(b) are perspective views illustrating a compliant translational joint according to the first and a second embodiment of the present invention;

FIG. 3 is a perspective view schematically illustrating the three degrees of freedom of a conventional leaf spring;

FIG. 4 is a schematic plan view of the present invention;

FIG. 5 is a graph illustrating lateral stiffness versus beam spacing for a compliant translational joint according to the principles of the present invention;

FIG. 6 is a graph illustrating lateral stiffness versus beam thickness and beam length with constant width;

FIG. 7 is a graph illustrating lateral stiffness versus beam width and beam length with constant thickness;

FIG. 8 is a graph illustrating axial stiffness versus beam length and moment of inertia;

TABLE 2 is a comparative table illustrating the functional difference of a third embodiment of the present invention relative to known prior art;

FIGS. 9(a)-(b) are perspective views illustrating a compliant revolute joint according to the third and a fourth embodiment of the present invention;

FIG. 10 is a partial schematic perspective view of the third embodiment of the present invention;

FIG. 11 is a schematic end view of the planar members;

FIG. 12 is a graph illustrating rotational stiffness versus beam width and percent ratio t/d for a compliant revolute joint according to the principles of the present invention;

FIG. 13 is a graph illustrating rotational stiffness versus beam width and beam length with constant thickness;

FIG. 14 is a graph illustrating rotational stiffness versus beam thickness and beam length with constant width;

FIG. 15 is a graph illustrating cross-axis stiffness versus beam length and beam width with constant thickness;

FIG. 16 is a perspective view illustrating a compliant revolute joint according to a fifth embodiment of the present invention;

FIG. 17 is a perspective view illustrating a compliant revolute joint according to a sixth embodiment of the present invention; and

FIG. 18 is a perspective view illustrating a compliant revolute joint according to a seventh embodiment of the present invention.

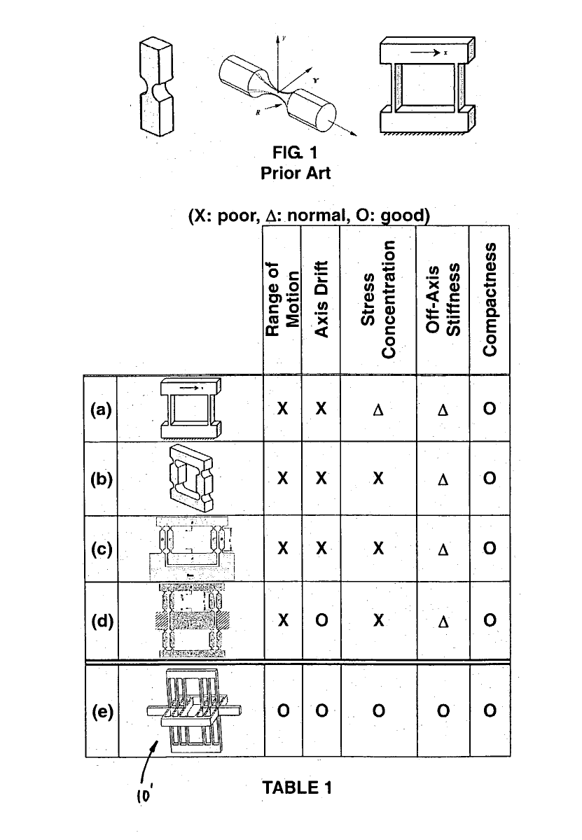

### DETAILED DESCRIPTION OF THE PREFERRED EMBODIMENTS

The following description of the preferred embodiments is merely exemplary in nature and is in no way intended to limit the invention, its application, or uses.

As mentioned above, primitive joints previously developed typically fall into one of two categories: notch joints or leaf spring joints. These joints are often combined in assemblies and most commonly used as revolute joints, universal joints, or parallel four-bar translational joints. Most commercially available flexible joints are such derivatives of the primitive joints, with the addition of any variety of packaging and connections to suit particular application requirements.

Compliant Translational Joints

Many prior art translational joints are based on a parallel four-bar building block. Their flexibility is derived from leaf springs (Table 1(a)) or notch joints (Table 1(b)). The compound four-bar joints in Table 1(c) and Table 1(d) deliver a larger range of straight-line motion. All four joints have acceptable off-axis stiffness, but the range of motion is very limited, even for the compound joints.

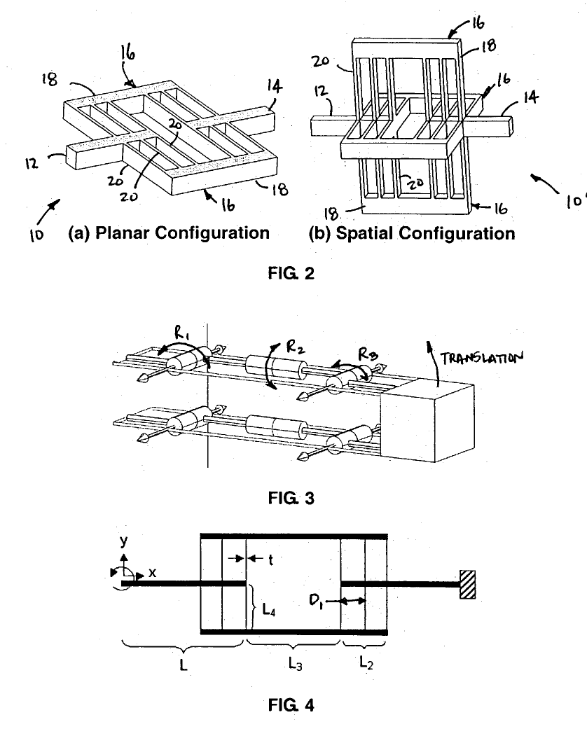

With particular reference to Table 1(e) and FIGS. 2(a)-(b), a compliant translational joint according to the principles of the present invention is provided, generally indicated at 10. Compliant translational joint 10 generally includes an input member 12, and output member 14, and a plurality of wing members 16. Each of the plurality of wing members 16 includes a connector member 18 and a plurality of leaves or beams 20 interconnecting each of input member 12 and output member 14 to a corresponding connecter member 18.

Still referring to Table 1(e) and FIGS. 2(a)-(b), each of the plurality of wing members 16 is generally planar in construction and may be arranged in planar arrangement with adjacent wing members (see FIG. 2(a)) or at an angular arrangement with adjacent wing members (see orthogonal arrangement of FIG. 2(b)), each being symmetrical about the longitudinal axis of compliant translational joint 10.

Additionally, each of the plurality of leaves 20 is preferably arranged in parallel relationship (i.e. parallelogram) with adjacent leaves as illustrated. As is generally known, leaf springs joints typically include three degrees of freedom (DOF) as illustrated in FIG. 3, namely R₁, R₂, and R₃. However, in designing a translational joint, it is desirable to constrain the rotational DOF, R₂. Such desirable feature is achieved in the present invention through the use of the parallelogram arrangement.

The remaining degrees of freedom (R₁ and R₃) normally allow rotation and translation at the tip of a single plate. However, the parallelogram arrangement of the present invention constrains the rotation, creating a curvilinear trajectory. Thus, a single parallelogram configuration does not generate straight-line motion. To eliminate the axis drift, a symmetric folded configuration of plates is used as seen in FIG. 2(a). By using a set of four parallelograms in an over-constrained arrangement of parallel beams (leaf springs), compliant translational joint 10 ensures parallelism between input member 12 and output member 14.

The off-axis (lateral) stiffness of compliant translational joint 10 is due to the axial stiffness of the plurality of leaves 20 and is therefore proportional to the cross-section area, A, of each leaf 20. Beam bending provides the axial (translational) stiffness, which is therefore proportional to the area moment of inertia, I_{B}. Increasing the ratio of the off-axis stiffness to the axial stiffness requires increasing the area A while decreasing the area moment of inertia, I_{B}. This is accomplished in compliant translational joint 10 by using groups of three parallel leaves 20 rather than 2. The formulas for the simple two and three beam cases are derived in Table 3. The last row of the table shows that by increasing the number of leaves 20 while keeping the total area constant, the stiffness ratio is increased by 9/4=2.25.

Using distributed compliance in long beams, rather than lumped compliance in short and narrow beams, enables greater displacements before local joint yielding. Having multiple thin beams further increases the range of motion. Furthermore, the load is distributed among all the beams and thin beams can flex farther than thick beams before the maximum bending stress is reached.

Additionally, when off-axis forces are applied outside of the group of beams, the 3-beam construction of the present invention offers the benefit of reduced compressive loads. With only two beams under such loading, both are in compression. For three beams, however, two are in compression while the beam farthest from the applied load is in tension. With both tension and compression loads present, the load in each beam is reduced.

Straight-line motion is achieved by the symmetry of the configuration. As seen in FIG. 2(a), the planar compliant translational joint 10 has two sets of leaf springs symmetric about the longitudinal axis. Similarly, as seen in FIG. 2(b), the spatial compliant translational joint 10′ is two planar compliant translational joints intersecting at 90 degrees, giving it rotational symmetry about its axis of motion.

Mathematical models of the planar and spatial compliant translational joints 10′ may be used to provide initial and rapid design modification. Stiffness matrices may be obtained using linear beam theory. That is, while the displacements being analyzed are large compared to notch-type joints, they are still relatively small when considered as cantilevers and remain in the realm of linear theory.

The flexibility of compliant translational joint 10 comes from simple cantilever elements (leaves) 20 of rectangular cross-section. The remaining elements (i.e. connectors 18) are considered rigid for purposes of mathematical modeling. Calculating the axial translational stiffness is relatively straightforward; the structure of the planar compliant translational joint 10 is two sets of six parallel cantilever beams 20 connected in series. The resulting axial stiffness is 3 times that of a single beam. The remaining off-axis stiffness, however, cannot be calculated in such a straightforward manner. Analytic expressions are calculated using the parameterized model in FIG. 4.

The two-dimensional model is fully constrained at one end and has a general axial force, lateral force, and moment applied at the free end. The solution of the linear system of Euler beam equations leads to the stiffness matrix:

$$\begin{matrix}k = [ \begin{matrix}{k}_{11} & 0 & 0 \\ 0 & {k}_{22} & {k}_{23} \\ 0 & {k}_{23} & {k}_{33}\end{matrix} ] \\ \begin{matrix}{k}_{11} = 3 \frac{{Et}^{3} w}{{L}_{4}^{3}} \vert {k}_{22} = 3 \frac{Etw ( 2 {L}_{2}^{2} + {t}^{2} )}{{L}_{4} ( 5 {L}_{2}^{2} + 6 {L}_{2} {L}_{3} + {t}^{2} + 3 {L}_{3}^{2} )} \\ {k}_{23} = \frac{3 Etw ( {L}_{3} + 2 L ) ( 2 {L}_{2}^{2} + {t}^{2} )}{2 {L}_{4} ( 5 {L}_{2}^{2} + 6 {L}_{2} {L}_{3} + {t}^{2} + 3 {L}_{3}^{2} )} \\ {k}_{33} = \frac{Etw ( \begin{matrix}4 {t}^{4} + 22 {t}^{2} {L}_{2}^{2} + 12 {t}^{2} {L}^{2} + 15 {t}^{2} {L}_{3}^{2} + 24 {t}^{2} {L}_{2} {L}_{3} + \\ 12 {t}^{2} {L}_{3} L + 12 {L}_{2}^{3} {L}_{3} + 24 {L}_{2}^{2} {L}_{3} L + 24 {L}_{2}^{2} {L}^{2} + 10 {L}_{2}^{4}\end{matrix} )}{4 {L}_{4} ( 5 {L}_{2}^{2} + 6 {L}_{2} {L}_{3} + {t}^{2} + 3 {L}_{3}^{2} )}\end{matrix}\end{matrix}$$

It should be noted that the k₁₁ term in the matrix equals that already predicted by adding the springs in series and parallel, i.e. three times that of an individual beam. For clarity, the stiffness of compliant translational joint 10 is listed in the following table. The ratio of each component with respect to the axial stiffness is included to demonstrate the effectiveness of the joint. The dimensions used are width (w)=10 mm, t=1 mm, L4=35 mm, L =52.5mm, L2=12 mm, and E=200 GPa.

| Stiffness | Value | | Ratio to k₁₁ |
|---|---|---|---|
| k₁₁ | 140 | N/mm | 1 |
| k₂₂ | 8489 | N/mm | 61 |
| k₂₃ | 577264 | N/rad | 4125 |
| | | | mm/rad |
| k₃₃ | 43425400 | N- | 310311 |
| | | mm/rad | mm²/rad |

The formulas for planar compliant translational joint 10 (see FIG. 2(a)) can be used to approximate the axial and lateral stiffness of spatial compliant translational joint 10′ (see FIG. 2(b)). With respect to axial stiffness, spatial compliant translational joint 10′ is essentially two planar joints working in parallel, giving the spatial compliant translational joint 10′ twice the stiffness of the planar compliant translational joint 10:

$${k ( spatial )}_{axial} = 6 \frac{{Et}^{3} w}{{L}_{4}^{3}}$$

For the off-axis lateral stiffness, the out-of-plane stiffness (k_{zz}) of planar compliant translational joint 10 is first estimated to be 3 Etw³/L³. In spatial compliant translational joint 10′, k₂₂ of one of planar compliant translational joints 10 acts in parallel with k_{zz} of the other. Added together, the joint's lateral stiffness is obtained:

$${k ( spatial )}_{lateral} = 3 \frac{Etw}{{L}_{4}} ( \frac{2 {L}_{2}^{2} + {t}^{2}}{5 {L}_{2}^{2} + 6 {L}_{2} {L}_{3} + {t}^{2} + 3 {L}_{3}^{2}} + \frac{{w}^{2}}{{L}_{4}^{2}} )$$

The following table lists the stiffness values of spatial compliant translational joint 10′ with the same parameters used in the above example for planar compliant translational joint 10. Spatial compliant translational joint 10′ offers an improved ratio of lateral to axial stiffness of 80.3.

| Stiffness | Value |
|---|---|
| kₐₓᵢₐₗ | 280 N/mm |
| kₗₐₜₑᵣₐₗ | 22483 N/mm |

An initial optimization study of the analytic stiffness matrix indicates some general trends. When attempting to maximize the ratio of lateral stiffness to axial stiffness, beam length and interbeam spacing (L₂) tend to be maximized, while the beam cross-section and the gap between the two-halves of the joint (L₃) tend to be minimized.

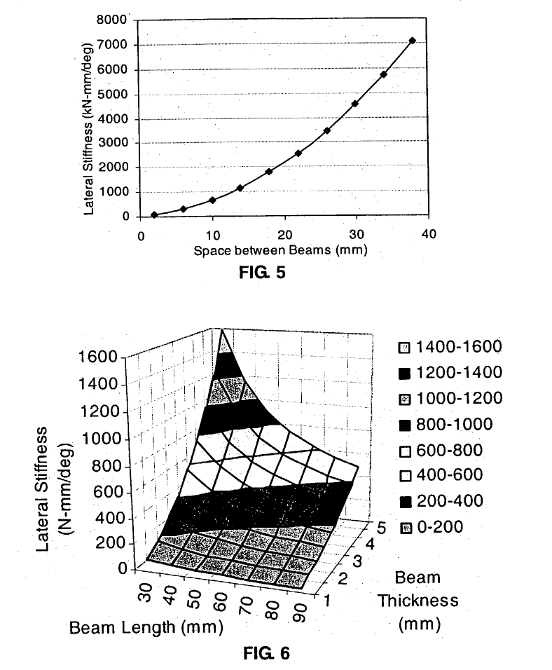

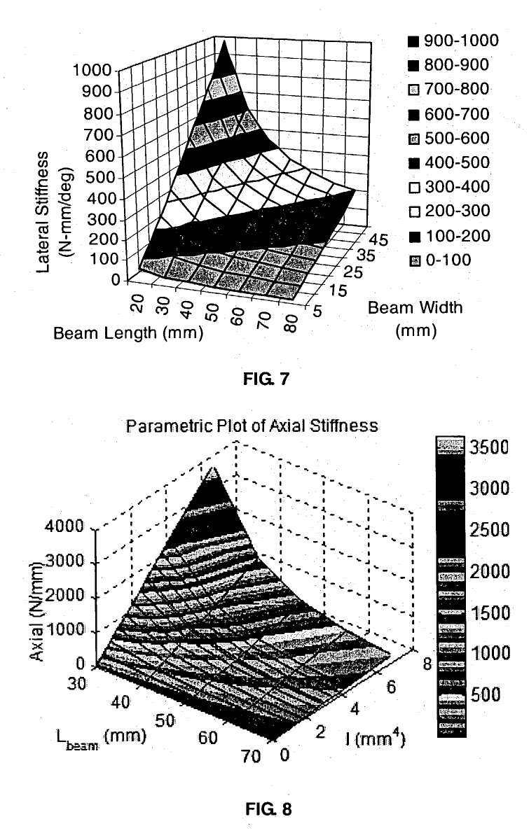

With reference to FIGS. 5-8, the above analysis has been applied in graphical form to facilitate the selection of appropriate parameters in light of desired structural properties. Specifically, FIG. 5 illustrates the relationship between the distance between adjacent beams 18, generally indicated as D₁ (see FIG. 4), and lateral stiffness as the cross-sectional area of each beam 18 is held constant. Further, FIG. 6 is a three-dimensional graph that illustrates the relationship of beam thickness, t, and beam length, L₄, relative to lateral stiffness as gap, L₃, remains constant. Still further, FIG. 7 is a three-dimensional graph that illustrates the relationship of beam width and beam length, L₄, relative to lateral stiffness as beam thickness, t, and gap, L₃, remain constant. Finally, FIG. 8 is provided to evaluate the parametric effects on axial stiffness, using beam length and moment of inertia about the axis of bending of a single beam, I_{B}, as the variables. The analytic equations predict that the axial stiffness should only be a function of I_{B}, which takes into account both the beam width and thickness. This direct dependence holds only for the axial stiffness; the lateral stiffness has a more complex dependence on beam width and thickness, requiring the two separate studies shown in the previous figures. It is important to note that in FIG. 8, the moment of inertia, I, has a linear effect on axial stiffness while the beam length has an inverse relationship with axial stiffness, both of which are predicted by the analytic formula kₐₓᵢₐₗ=72 EI_{B}/L³.

Accordingly, compliant translational joint 10, 10′ provides an improved system relative to conventional leaf spring designs. Specifically, compliant translational joint 10, 10′ includes three beams in each group rather than two beams or less as is common in leaf spring designs. This configuration increases the stability of compliant translational joint 10, 10′ by increasing the cross sectional area of the joint and by making at least two beams of the three experience compression forces rather than only one beam in a conventional leaf spring design. Therefore, compliant translational joint 10, 10′ of the present invention is capable of tolerating high loads and thus provides a larger range of motion relative to conventional leaf spring designs.

Compliant Revolute Joints

Similarly, many prior art revolute joints are based on the use of notch and/or leaf spring primitives. For example, Table 2(a) illustrates a spherical joint created by a cylindrical notch cut. Leaf springs can also be used in a variety of ways to create revolute joints, as illustrated in Table 2(b)-(g). However, it should be appreciated that many of the prior art multi-leaf spring joints offer only a limited range of motion, are often bulky, and have only moderate off-axis stiffness. Universal joints fabricated from circular leaf springs are illustrated in Table 2(h)-(i). Both of these joints also provide axial translation, which is useful in self-alignment applications. However, they both have stress concentrations, which limit their ranges of motion.

Another prior art joint, specifically a split-tube revolute joint, is illustrated in Table 2(j). This joint offers the off-axis stiffness of a solid circular tube while having a low torsional stiffness. While the axis drift of a split-tube is small, it is not zero. Perfect rigidity would require infinitely thin line contact between the connecting link and the tube. Further, this joint exhibits a tradeoff between range of motion and off-axis stiffness. Under large displacements, the gap separation increases and the tube warps out of circular shape, greatly reducing the off-axis stiffness.

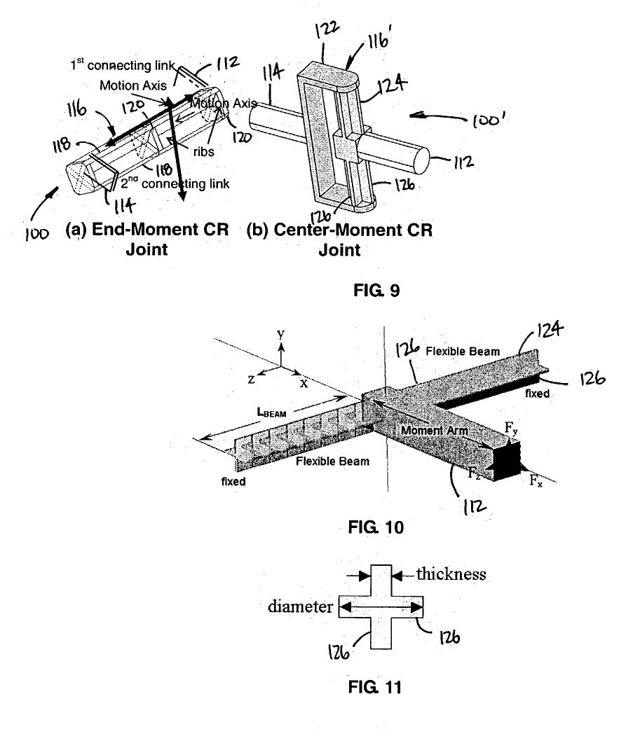

With particular reference to Table 2(k) and FIGS. 9(a)-(b), a compliant revolute joint according to the principles of the present invention is provided, generally indicated at 100, which is designed to generate pure rotational motion. A first embodiment, generally referred to as an end-moment compliant revolute joint 100 generally includes an input member 112, and output member 114, and a connecting joint 116. Connecting joint 116 generally includes a pair of longitudinally extending planar members 118 joined orthogonally together to generally define an X-shape, when viewed in cross-section. Optional ribs 120 may be disposed orthogonal to the longitudinal axis of connecting joint 116 to span each of the pair of planar members 118 for added structural integrity, to prevent bending, and to reduce cross sections to provide torsional compliance.

Still referring to Table 2(k) and FIGS. 9(b), a second embodiment, generally referred to as a center-moment compliant revolute joint 100′ generally includes an input member 112, and output member 114, and a connecting joint 116′. Connecting joint 116′ generally includes a U-shaped member 122 coupled to either input member 112 or output member 114 at a midpoint of U-shaped member 112. A corresponding member 124 is coupled to the other of the input member 112 or output member 114 at a midpoint of corresponding member 124. Corresponding member 124 preferably includes a pair of planar members 126 joined orthogonally together to generally for an X, when viewed in cross-section. Optional ribs (not shown), similar to ribs 120, may be disposed orthogonal to the longitudinal axis of corresponding member 124 to span each of the pair of planar members 126 for added structural integrity.

Most of the stiffness components of compliant revolute joint 100, 100′, except for the primary rotational stiffness, can be calculated with standard beam formulas. A cruciform hinge is a torsion bar with a cross-shaped cross-section, depicted in FIG. 9(a). Compliant revolute joint 100 is considered as two cruciform hinges used in parallel (FIG. 10). Due to symmetry and the assumption of linearity, the resulting 6×6 spatial stiffness matrix is purely diagonal. The six diagonal elements, based on the coordinates of FIG. 10, are given in the following table, where “w” and “t” represents the width and thickness, respectively, as illustrated in FIG. 11. The formula used for torsional stiffness is accurate to within 4% of the actual value.

| | | |
|---|---|---|
| Torsional Stiffness | k₆₆ (M_{z}/θ_{z}) | $( \frac{w}{t} - 0.373 ) \frac{4 {Gt}^{4}}{2 L}$ |
| Bending/ | k₄₄ (Mₓ/θₓ), k₅₅ | 2 EI/L |
| Rotational | (M_{y}/θ_{y}) | |
| Stiffness | | |
| Bending | k₁₁ (Fₓ/dₓ), k₃₃ | 24 EI/L³ |
| Stiffness | (F_{z}/d_{z}) | |
| Axial | k₂₂ (F_{y}/d_{y}) | 2 AE/L |
| Stiffness | | |

Note:
Iₓ = I_{y} = I = 1/12*(wt³ + tw³ − t⁴); A = 2wt − t²

The stiffness for a typically sized compliant revolute joint 100 are calculated and displayed in the following table. The dimensions used are width=10 mm, thickness=1 mm, beam length=50 mm, moment arm=55 mm. To illustrate the benefits of this joint, the ratio of each off-axis stiffness with respect to the torsional stiffness is also included.

| Stiffness | | Value | Ratio to k₆₆ |
|---|---|---|---|
| Torsional | k₆₆ (M_{z}/θ_{z}) | 20,589 N-mm/rad | 1 |
| Bending/ | k₄₄ (Mₓ/θₓ), k₅₅ | 696,210 N-mm/rad | 33.8 |
| Rotational | (M_{y}/θ_{y}) | | |
| Bending | k₁₁ (Fₓ/dₓ), k₃₃ | 3,342 N/mm | 491 |
| | (F_{z}/d_{z}) | | |
| Axial | k₂₂ (F_{y}/d_{y}) | 157,320 N/mm | 23,114 |

Because translational and rotational stiffness have different units, their ratio has units of radians/mm2, which indicates dependence on the length of the moment arm (MA). Dimensionless values are attained by multiplying these ratios by MA². In the above table, (MA=55 mm), multiplying the direct ratios (k₁₁/k₆₆=0.1623 rad/mm2 and k₂₂/k₆₆=7.6410 rad/mm2) by (55mm)² gives the modified ratios of k₁₁/k₆₆=491 and k₂₂/k₆₆=23,114. With the smallest off-axis ratio at 33.8 and the others much higher, it is evident that this is a very effective flexible joint. From further analysis of compliant revolute joint 100 using a width=10 mm, thickness=1 mm, beam length=50 mm, moment arm=55 mm, the Center of Rotation Drift (CRD) has been determined to be minimal. During normal moment-loaded operation there is no CRD for any degree of rotation. If x-direction loading is present during operation, it contributes only 215 nm to the CRD per Newton of applied force, Fx. These values indicate negligible drift for practical applications.

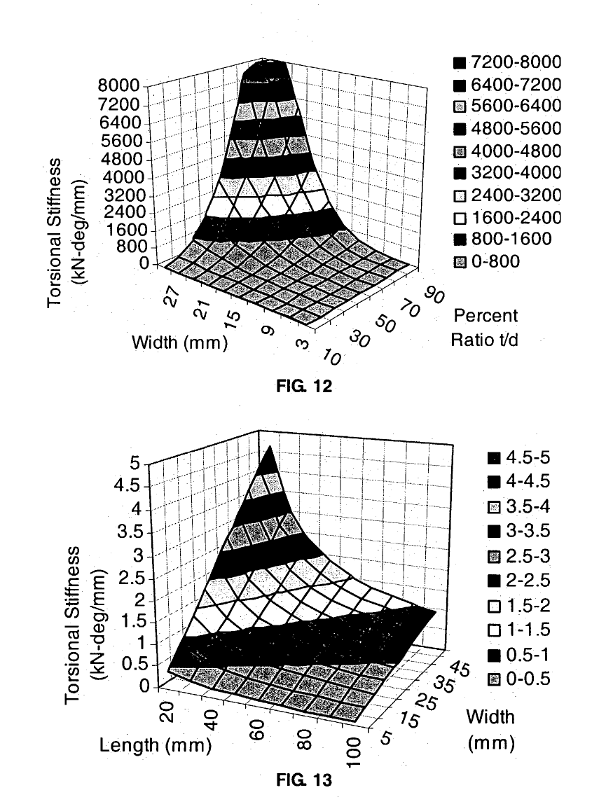

With reference to FIGS. 12-15, the above analysis has been applied in graphical form to facilitate the selection of appropriate parameters in light of desired structural properties. Specifically, the first quantity considered is the desired motion of the joint—torsional compliance when a force is applied in the y-direction. To maximize the desired compliance, the torsional stiffness, illustrated in FIGS. 12 and 13, must be minimized. FIG. 12 indicates that stiffness decreases nonlinearly with respect to width when the RTW is constant and vice versa. FIG. 13 illustrates the combined effects of beam length and width on the torsional stiffness. Beam width has only a linear effect on stiffness for a given beam length. However, beam length nonlinearly decreases the stiffness for a given width.

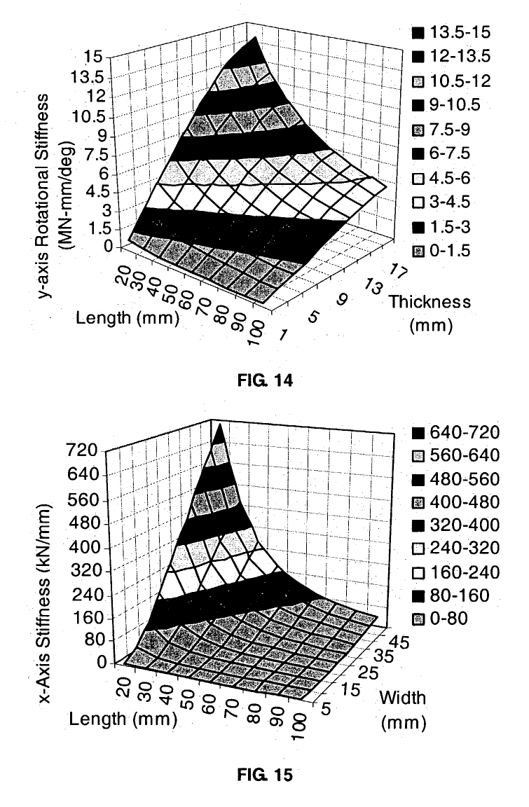

While FIGS. 12 and 13 suggest small widths, small thicknesses, and long beams for minimal torsional stiffness, these conflict with the requirements for maximum off-axis stiffness. As seen in FIG. 14, which illustrates the rotational bending stiffness for an axially applied load, it is evident that maximum bending stiffness requires shorter beams with thicker flanges. This contradiction verifies the need for a design tool to balance both objectives.

FIG. 15 illustrates the stiffness of compliant revolute joint 100 when it is loaded as a fixed-fixed beam with a perpendicular force (i.e. x-direction) applied at its center. Increased width and reduced length are required to increase the x-axis stiffness. The effect of width is nearly linear for a given length, but the length has a nonlinear effect for a constant width.

The length of the moment arm (MA) was not included in the above figures because its effect on compliant revolute joint 100 can be easily summarized in a single chart as shown below. These relationships are almost entirely unaffected by the other parameters.

| | |
|---|---|
| x-axis stiffness (Fₓ/dₓ) | independent of MA |
| y-axis stiffness (F_{y}/d_{y}) | ˜proportional to MA² |
| z-axis stiffness (F_{z}/d_{z}) | ˜proportional to MA² |
| y-axis rotational stiffness | directly proportional to MA |
| (F_{z}/θ_{y}) | |
| z-axis rotational stiffness | directly proportional to MA |
| (F_{y}/θ_{z}) | |

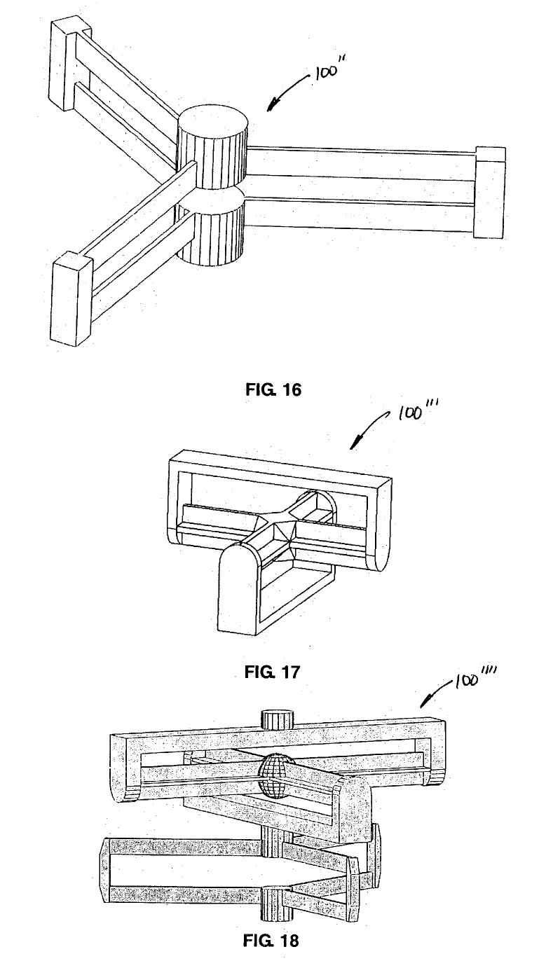

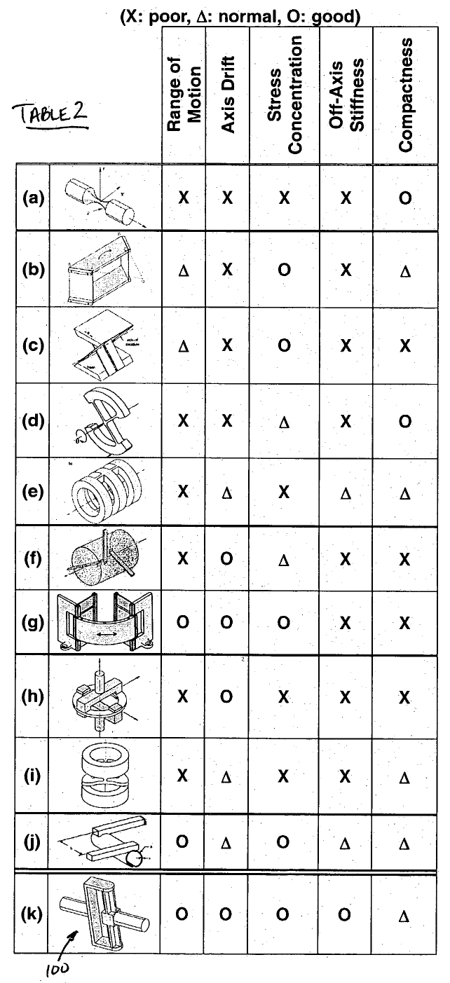

In light of the above, it should be understood that additional configurations may be used to minimize/maximize selected properties and/or package size. For example, compliant revolute joint 100″ is contemplated, as shown in FIG. 16, which allows for the tradeoff of joint footprint in the xy-plane and joint depth in the z-direction. To further increase the library of compliant joints for the design of generic mechanisms, two compliant revolute joints may be concatenated to create a compliant universal (CU) joint 100′″, as seen in FIG. 17. The CU joint 100′″ allows only two rotational degrees of freedom, as does its traditional mechanical counterpart. However, a Compliant Spherical (CS) joint 100″″ with 3 degrees of freedom can be built by connecting compliant universal joints 100′″ with compliant revolute joints 100 as demonstrated in FIG. 18.

According to the principles of the present invention, new types of compliant joints for rotational and translational motions are provided. These new compliant joint designs allow for a larger range of motion than that of the conventional flexure joints. For the compliant revolute joint, the smallest and largest off-axis stiffness are 33 and 23,000 times the joint stiffness, respectively. The compliant translational joint has off-axis stiffness 80 times greater than its axial stiffness. Further, the overconstrained compliant translational joint delivers exact straight-line motion and the rotation axis of the compliant revolute joint drifts only 140 nm for ±90° motions.

The present invention provides a number of useful advantages over known prior art. For example, the compliant joints of the present invention provide larger ranges of motion relative to convention flexure joints because of their symmetric configuration, which allows them to maintain motion characteristics even when the beam members are out of linear deformation ranges. Additionally, the compliant joints of the present invention further exhibit low stress concentrations because the beam members themselves are used to provide compliance. Therefore, any stress produce during displacement (deformation) is distributed over the length of each beam member. Therefore, the compliant joints of the present invention avoid stress concentrations normally found in notch-type compliant joints.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A joint member for interconnecting a first member to a second member, said joint member comprising:
an input member;
an output member;
a first group of at least three generally-planar beam members fixedly coupled to said input member, each of said first group of at least three generally planar beam members being positioned generally parallel to another of said first group of at least three generally planar beam members;
a second group of at least three generally-planar beam members fixedly coupled to said output member, each of said second group of at least three generally planar beam members being positioned generally parallel to another of said second group of at least three generally planar beam members; and
a first pair of connecting members coupling said first group of said at least three generally planar beam members with said second group of said at least three generally planar beam members.

2. The joint member according to claim 1, further comprising:
a third group of at least three generally-planar beam members fixedly coupled to said input member, each of said third group of at least three generally planar beam members being positioned generally parallel to another of said third group of at least three generally planar beam members;
a fourth group of at least three generally-planar beam members fixedly coupled to said output member, each of said fourth group of at least three generally planar beam members being positioned generally parallel to another of said fourth group of at least three generally planar beam members; and
a second pair of connecting members coupling said third group of said at least three generally planar beam members with said fourth group of said at least three generally planar beam members.

3. The joint member according to claim 2 wherein said third and fourth groups of at least three generally planar beam members are generally arranged orthogonal to said first and second groups of at least three generally planar beam members.

4. The joint member according to claim 1 wherein a ratio of an axial stiffness of the joint member to a lateral stiffness of the joint member is greater than about 40:1.

5. The joint member according to claim 4 wherein said ratio of axial stiffness of the joint member to lateral stiffness of the joint member is greater than about 70:1.

6. The joint member according to claim 1 wherein said input member and said output member are coaxial.

7. A joint member for interconnecting a first member to a second member, said joint member comprising:
an input member;
an output member;
a generally U-shaped member coupled to one of said input member and said output member; and
a beam member coupled to the other of said input member and said output member at generally a midpoint thereof, said beam member having opposing ends fixedly coupled to opposing ends of said generally U-shaped member.

8. The joint member according to claim 7 wherein said beam member comprises:
a pair of planar members joined along a longitudinal axis thereof.

9. The joint member according to claim 7 wherein a ratio of a bending stiffness of the joint member to a torsional stiffness of the joint member is greater than about 25:1.

10. The joint member according to claim 7 wherein a ratio of an axial stiffness of the joint member to a torsional stiffness of the joint member is greater than about 10,000:1.

11. A joint member for interconnecting a first member to a second member, said joint member comprising:
an input member;
an output member;
a first group of at least three beam members coupled to and extending radially outwardly from said input member;
a second group of at least three beam members coupled to and extending radially outwardly from said output member; and
at least three connecting members each fixedly coupling one of said first group of at least three beam members to a corresponding one of said second group of at least three beam members.
